(19) United States
(12) Patent Application Publication
(10) Pub. No.: US 2025/0358899 A1
(43) Pub. Date: Nov. 20, 2025

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/288,912

(22) Filed: Aug. 1, 2025

Related U.S. Application Data
(63) Continuation of application No. PCT/JP2024/003195, filed on Feb. 1, 2024.

(30) Foreign Application Priority Data
Feb. 1, 2023 (JP) 2023-013874

(51) Int. Cl. H04W 76/40; H04W 76/27

(52) U.S. Cl. CPC H04W 76/40; H04W 76/27

(57) ABSTRACT

A communication method to be used in a mobile communication system providing a Multicast/Broadcast Service (MBS) includes receiving, at a base station, a message including user equipment information and/or session identification information from a network apparatus provided in a core network. The user equipment information indicates a user equipment that has already joined a multicast session and is allowed for multicast reception in a radio resource control (RRC) inactive state. The session identification information indicates a multicast session that allows for reception in the RRC inactive state.

### RELATED APPLICATIONS

The present application is a continuation based on PCT Application No. PCT/JP2024/003195, filed on Feb. 1, 2024, which claims the benefit of Japanese Patent Application No. 2023-013874 filed on Feb. 1, 2023. The content of which is incorporated by reference herein in their entirety.

### TECHNICAL FIELD

The present disclosure relates to a communication method to be used in a mobile communication system.

### BACKGROUND

The 3rd Generation Partnership Project (3GPP) (trade name, the same applies hereinafter) has defined technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of a Multicast/Broadcast Service (MBS) of the 5G/NR.

In the 3GPP Release 17, only a user equipment in a radio resource control (RRC) connected state is allowed for MBS multicast reception (i.e., multicast reception) (see, for example, Non-Patent Document 1). On the other hand, in the 3GPP Release 18, technical specifications are scheduled to be enhanced such that a user equipment in an RRC inactive state can perform the multicast reception.

### CITATION LIST

### Non-Patent Literature

Non-Patent Document 1: 3GPP Technical Specification: TS 38.300 V17.3.0

### SUMMARY

A communication method according to a first aspect is a communication method to be used in a mobile communication system providing a Multicast/Broadcast Service (MBS). The communication method includes: receiving, at a base station, a message including predetermined information relating to the MBS from a network apparatus provided in a core network; determining, at the base station, a user equipment to receive a multicast session in an RRC inactive state based on the predetermined information; and transmitting, at the base station, an RRC Release message including configuration information for the user equipment to receive the multicast session in the RRC inactive state to the user equipment.

A communication method according to a second aspect is a communication method to be used in a mobile communication system providing a Multicast/Broadcast Service (MBS). The communication method includes: receiving, at a user equipment in an RRC connected state, scheduling information of a multicast control channel (MCCH) carrying a point-to-multipoint (PTM) configuration of a multicast session from a base station with dedicated signaling; receiving the PTM configuration through the MCCH from the base station based on the scheduling information of the MCCH; and receiving the multicast session from the base station based on the PTM configuration.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane for handling data.

FIG. 5 is a diagram illustrating a configuration of a protocol stack of a radio interface of a control plane handling signaling (control signal).

FIG. 6 is a diagram indicating an MBS Broadcast Configuration (MBSBroadcastConfiguration) message in an MCCH defined in the RRC Technical Specification (TS38.331).

FIGS. 7A and 7B are a diagram illustrating an overview of an operation for allowing a UE 100 in an RRC inactive state to perform multicast reception.

FIG. 8 is a diagram for explaining an operation of the mobile communication system according to a first embodiment.

FIG. 9 is a table for explaining a first operation pattern in the first embodiment.

FIG. 10 is a diagram for explaining a second operation pattern in the first embodiment.

FIG. 11 is a diagram for explaining the second operation pattern in the first embodiment.

FIG. 12 is a diagram for explaining the second operation pattern in the first embodiment.

FIG. 13 is a diagram illustrating an example of an operation sequence of the mobile communication system according to the first embodiment.

FIG. 14 is a diagram for explaining an operation example (comparative example) when a distribution mode 2 is applied to an MBS multicast.

FIG. 15 is a diagram indicating a configuration of SIB 20 defined in the RRC Technical Specification (TS38.331) of the 3GPP Release 17.

FIG. 16 is a diagram for explaining an operation of a mobile communication system according to a second embodiment.

FIG. 17 is a diagram illustrating an example of an operation sequence of the mobile communication system according to the second embodiment.

### DESCRIPTION OF EMBODIMENTS

A mobile communication system according to an embodiment is described with reference to the drawings. In the description of the drawings, the same or similar parts are denoted by the same or similar reference signs.

### (1) First Embodiment

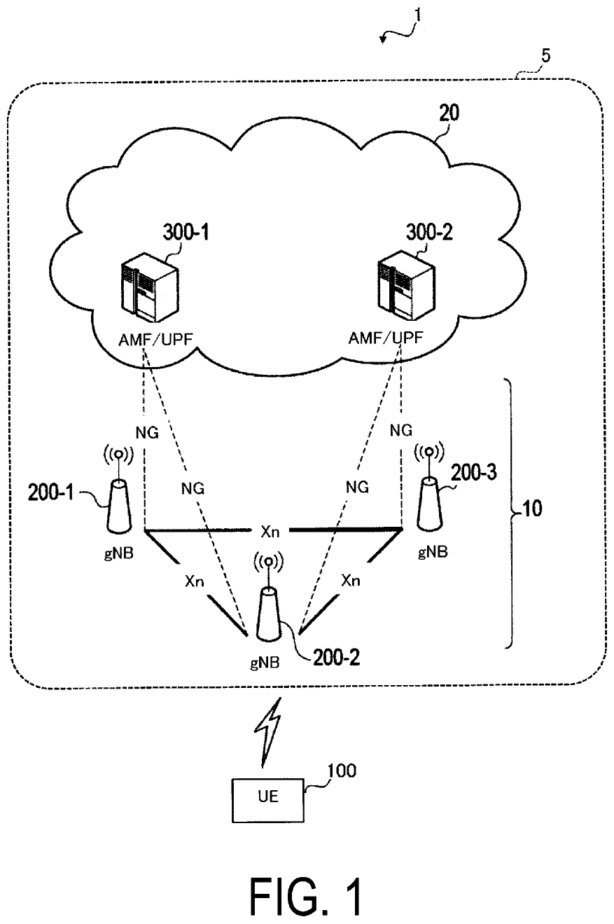

A first embodiment will be described with reference to FIGS. 1 to 11.

### (1.1) System Configuration

FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) that is a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

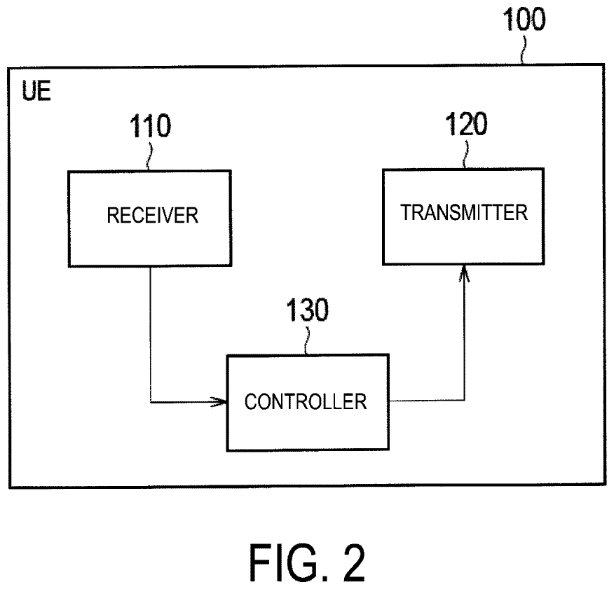

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may be also performed under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

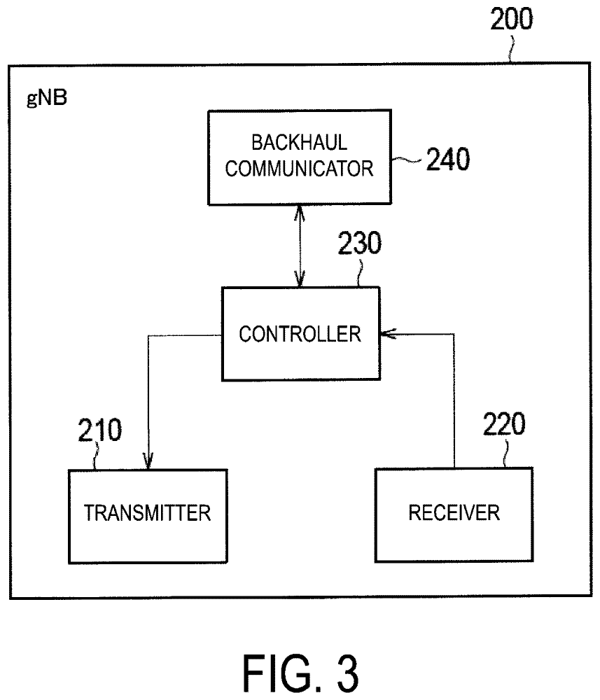

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may be also performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

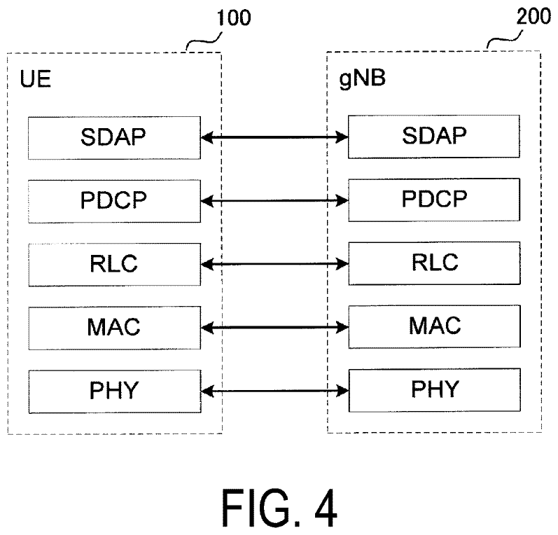

FIG. 4 is a diagram illustrating a configuration of a protocol stack of a radio interface of a user plane for handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE. A Cyclic Redundancy Code (CRC) parity bit scrambled by the RNTI is added to the DCI transmitted from the gNB 200.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between an IP flow as a unit of Quality of Service (QOS) control performed by a core network and a radio bearer as a unit of QoS control performed by an Access Stratum (AS). Note that, when the RAN is connected to the EPC, the SDAP need not be provided.

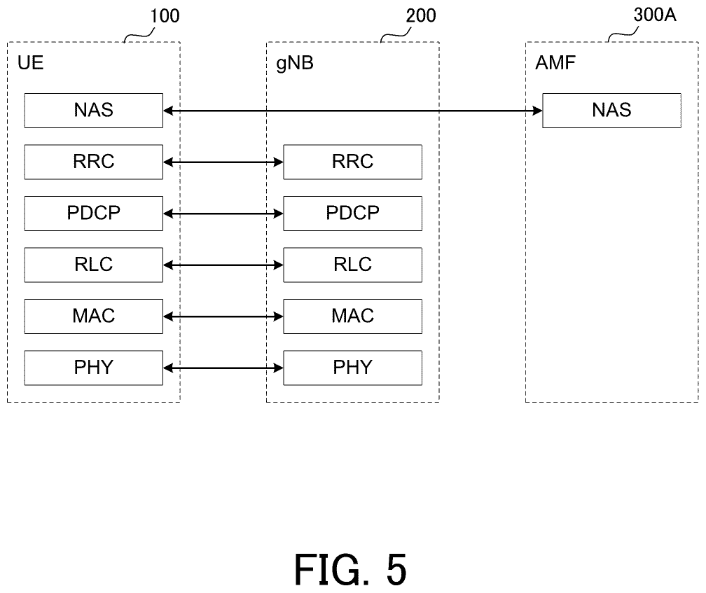

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) is established between RRC of the UE 100 and RRC of the gNB 200, the UE 100 is in an RRC connected state. When a connection (RRC connection) is not established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer (also referred to simply as an “NAS”) that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. Each layer lower than the NAS layer will be referred to as an AS layer (also referred to simply as an “AS”).

### (1.2) MBS

The mobile communication system 1 can perform distribution with high resource efficiency by using the Multicast/Broadcast Service (MBS).

In a case of a multicast communication service (also referred to as “MBS multicast”), the same service and the same specific content data are simultaneously provided to a specific set of UEs. That is, not every UE 100 in a multicast service area is allowed to receive data. The multicast communication services are distributed to the UE 100 using a multicast session that is a type of an MBS session. The UE 100 can receive the multicast communication services in the RRC connected state using mechanisms such as Point-to-Point (PTP) and/or Point-to-Multipoint (PTM) distribution. The UE 100 may receive the multicast communication services in the RRC inactive (or RRC idle) state. Such a distribution mode will be also referred to as “distribution mode 1”. Note that the UE 100 can receive the multicast session only after having joined a multicast session. Here, joining a multicast session may mean being registered in the network 5 (CN 20) as a UE 100 allowed to receive the multicast session.

In a case of the broadcast communication service (also referred to as “MBS broadcast”), the same service and the same specific content data are provided simultaneously to every UE 100 in a geographic area. That is, every UE 100 in a broadcast service area is allowed to receive the data. The broadcast communication services are distributed to the UE 100 using a broadcast session that is a type of an MBS session. The UE 100 can receive the broadcast communication services in any state of the RRC idle state, the RRC inactive state, and the RRC connected state. Such a distribution mode will be also referred to as “distribution mode 2”.

Main logical channels used for MBS distribution are a multicast traffic channel (MTCH), a dedicated traffic channel (DTCH), and a multicast control channel (MCCH). The MTCH is a PTM downlink channel for transmitting MBS data of a multicast session and/or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

In the MBS multicast, either point-to-point (PTP) transmission corresponding to unicast or point-to-multipoint (PTM) transmission can be applied to transmission of an MBS data packet (also referred to as an “MBS packet”). On the other hand, in the MBS broadcast, only PTM transmission can be applied. In a case of the PTP transmission, the gNB 200 can distribute an individual copy of an MBS packet to each UE 100 separately. For example, the gNB 200 may use a UE-specific PDCCH with a CRC scrambled by a UE-specific RNTI (e.g., C-RNTI) to schedule a UE-specific PDSCH scrambled by the UE-specific RNTI. On the other hand, in a case of the PTM transmission, the gNB 200 distributes a single copy of an MBS packet to a set (group) of multiple UEs 100. For example, the gNB 200 uses a group-common PDCCH with the CRC scrambled by a group-common RNTI to schedule a group-common PDSCH scrambled by the group-common RNTI.

Regarding a configuration of MBS broadcast, the UE 100 in the RRC idle state, the RRC inactive state, or the RRC connected state receives a PTM configuration for a broadcast session (e.g., parameters necessary for MTCH reception) via the MCCH. Parameters necessary for reception of the MCCH (MCCH configuration) are provided through system information. More specifically, system information block/type 20 (SIB 20) includes the MCCH configuration. Note that an SIB type 21 (SIB 21) includes information relating to service continuity of MBS broadcast reception. The MCCH provides a list of all broadcast services including ongoing sessions transmitted on the MTCH, and the related information of the broadcast session includes an MBS session identifier (e.g., Temporary Mobile Group Identity (TMGI)), related MTCH scheduling information, and information relating to neighboring cells providing a specific service on the MTCH.

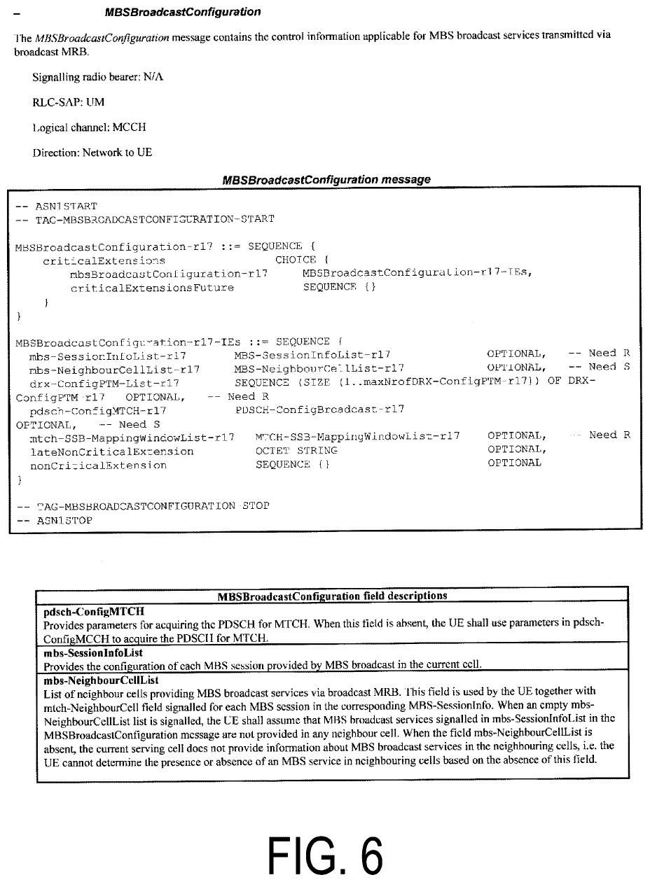

FIG. 6 is a diagram indicating an MBS Broadcast Configuration (MBSBroadcastConfiguration) message in the MCCH defined in the RRC Technical Specification (TS38.331). The MCCH includes an MBS session information list (mbs-SessionInfoList) providing a configuration of each MBS session (each broadcast session) provided through MBS broadcast in a current cell, a list of neighboring cells (mbs-NeighbourCellList) providing an MBS broadcast service through a broadcast MRB, a list of DRX configurations (drx-ConfigPTM-List), and a parameter (pdsch-ConfigMTCH) for acquiring the PDSCH for the MTCH.

On the other hand, as for MBS multicast, the current technical specifications of the 3GPP enable the UE 100 to receive data of multicast sessions only in the RRC connected state. When the UE 100 having joined a multicast session is in the RRC connected state and the multicast session is activated, the gNB 200 transmits an RRC reconfiguration (Reconfiguration) message including a PTM configuration relating to the multicast session to the UE 100. The PTM configuration above is also referred to as a multicast radio bearer (MRB) configuration, or an MTCH configuration. Such an MRB configuration (MRB-ToAddMod) includes an MBS session identifier (mbs-SessionId), an MRB identifier (mrb-Identity), and other parameters such as a PDCP configuration (pdcp-Config) for an MRB (multicast MRB) to be configured for the UE 100.

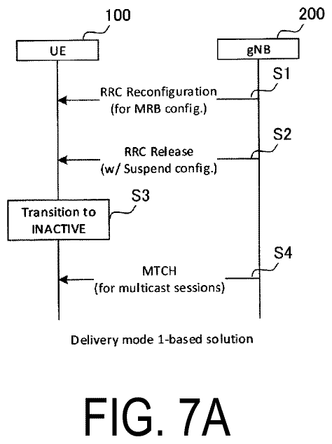

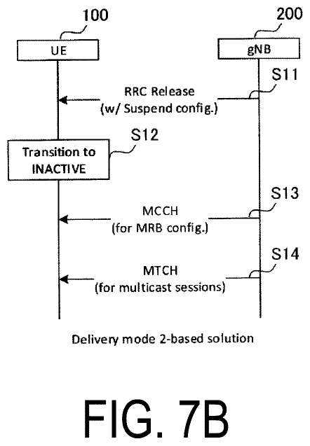

In the following embodiment, an operation of enabling the UE 100 in the RRC inactive state to perform multicast reception will be mainly described. FIGS. 7A and 7B are a diagram illustrating an overview of the operation.

As a solution for the UE 100 in the RRC inactive state to perform multicast reception, the distribution mode 1-based solution illustrated in FIG. 7A and the distribution mode-2 based solution illustrated in FIG. 7B are considered. It is assumed that the UE 100 supports multicast reception in the RRC inactive state and has already joined a multicast session.

In the distribution mode 1-based solution illustrated in FIG. 7A, in step S1, the gNB 200 transmits, to the UE 100 in the RRC connected state, an RRC Reconfiguration message including an MBS configuration (PTM configuration) relating to the multicast session. The UE 100 receives the multicast data on the MTCH through the multicast session (multicast MRB) based on the PTM configuration received in the RRC Reconfiguration message.

In step S2, the gNB 200 transmits to the UE 100 in the RRC connected state an RRC release (Release) message for causing the UE 100 to transition to the RRC inactive state. The RRC Release message includes a configuration (Suspend Config.) for the RRC inactive state.

In step S3, the UE 100 transitions from the RRC connected state to the RRC inactive (INACTIVE) state in response to reception of the RRC Release message in step S2.

In step S4, the UE 100 in the RRC inactive state continues using the PTM configuration in step S1 and receives the multicast data on the MTCH through the multicast session.

This enables the UE 100 in the RRC inactive state to perform multicast reception. Note that, there has been described an example in which PTM configuration is performed using the RRC Reconfiguration message, but the PTM configuration may be performed using the RRC Release message.

Both the RRC Reconfiguration message and the RRC Release message are RRC messages transmitted per UE on the Dedicated Control Channel (DCCH), and are hereinafter also referred to as dedicated RRC messages or dedicated signaling.

On the other hand, in the distribution mode 2-based solution illustrated in FIG. 7B, in step S11, the gNB 200 transmits, to the UE 100 in the RRC connected state, the RRC Release message for causing the UE 100 to transition to the RRC inactive state. The RRC Release message includes a configuration (Suspend Config.) for the RRC inactive state.

In step S12, the UE 100 transitions to the RRC inactive (INACTIVE) state in response to reception of the RRC Release message in step S11.

In step S13, the gNB 200 transmits the MCCH including the MBS configuration (PTM configuration) relating to the multicast session. The UE 100 receives the MCCH. Note that the UE 100 receives the SIB 20 prior to the reception of the MCCH, and receives the MCCH based on the SIB 20. Note that the MCCH transmission (and reception) may be performed before step S11 or may be performed simultaneously with step S11.

In step S14, the UE 100 in the RRC inactive state receives the multicast data on the MTCH through the multicast session based on the PTM configuration received through the MCCH in step S13. This enables the UE 100 in the RRC inactive state to perform multicast reception.

A solution is also conceivable in which the distribution mode 1-based solution and distribution mode 2-based solution are mixed. For example, a mixed configuration method is also possible in which an initial configuration of the MBS configuration (PTM configuration) is performed by the dedicated signaling and the update of the MBS configuration (PTM configuration) is performed by the MCCH.

### (1.3) Operation According to First Embodiment

As described above, the gNB 200 transmits the PTM configuration necessary for receiving the multicast session in the RRC inactive state to the UE 100 that has already joined the multicast session and supports the multicast reception in the RRC inactive state.

The gNB 200 then needs to be able to appropriately determine which UE 100 is caused to perform multicast reception in the RRC inactive state. However, the gNB 200 does not know the service characteristics of the multicast session (e.g., whether there is UL) and/or the terms and conditions of the UE 100 (e.g., whether the quality of multicast reception may be degraded to some extent) and the like. In the first embodiment, there will be described an operation (communication method) for the gNB 200 to appropriately determine which UE 100 is caused to perform multicast reception in the RRC inactive state.

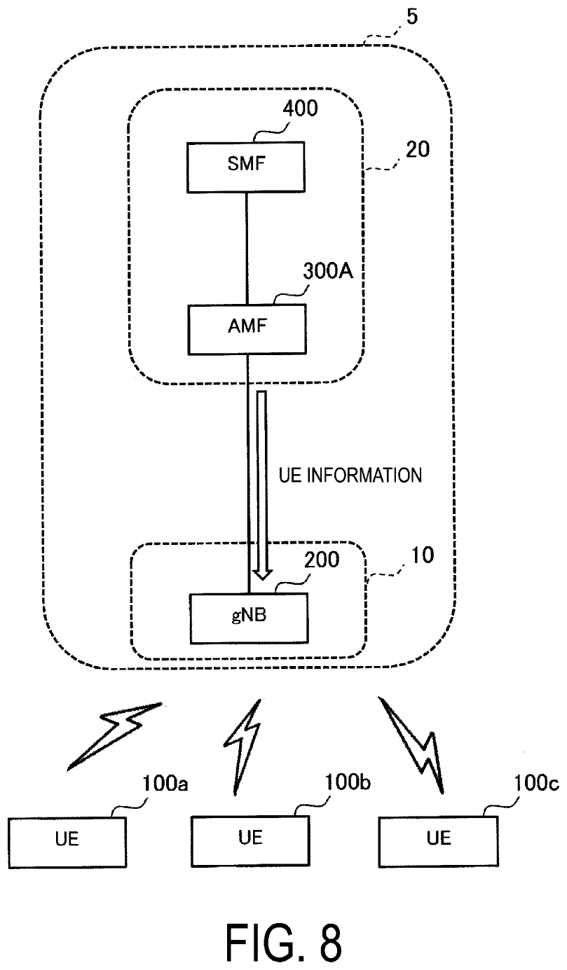

FIG. 8 is a diagram for explaining an operation (communication method) of the mobile communication system 1 according to the first embodiment.

In the communication method according to the first embodiment, the gNB 200 receives a message including UE information from a network apparatus provided in the CN 20. The UE information indicates the UE 100 that has already joined a multicast session and is allowed for multicast reception in the RRC inactive state. Thus, the gNB 200 can recognize, based on the UE information from the CN 20, the UE 100 that has already joined a multicast session and is allowed for multicast reception in the RRC inactive state. Accordingly, it becomes possible for the gNB 200 to appropriately determine which UE 100 is caused to perform multicast reception in the RRC inactive state. For example, the gNB 200 determines, based on the UE information, a UE 100 which is caused to perform multicast reception in the RRC inactive state and transmits to the UE 100 configuration information (PTM configuration) for the UE 100 to receive a multicast session in the RRC inactive state.

Here, the network apparatus provided in the CN 20 may be the AMF 300A or a Session Management Function (SMF) 400. The AMF 300A is a network apparatus that manages mobility of the UE 100 by communicating with the UE 100 using the NAS signaling. The AMF 300A communicates with the gNB 200 via the NG interface. On the other hand, the SMF 400 is a network apparatus that configures and releases a session being a data transfer path used by a service (application). The SMF 400 is connected to the AMF 300A via an interface with the AMF 300A.

In the first embodiment, the CN 20 transmits to the RAN 10 (gNB 200) a message including UE information indicating the UE 100 that has already joined a multicast session and is allowed for multicast reception in the RRC inactive state.

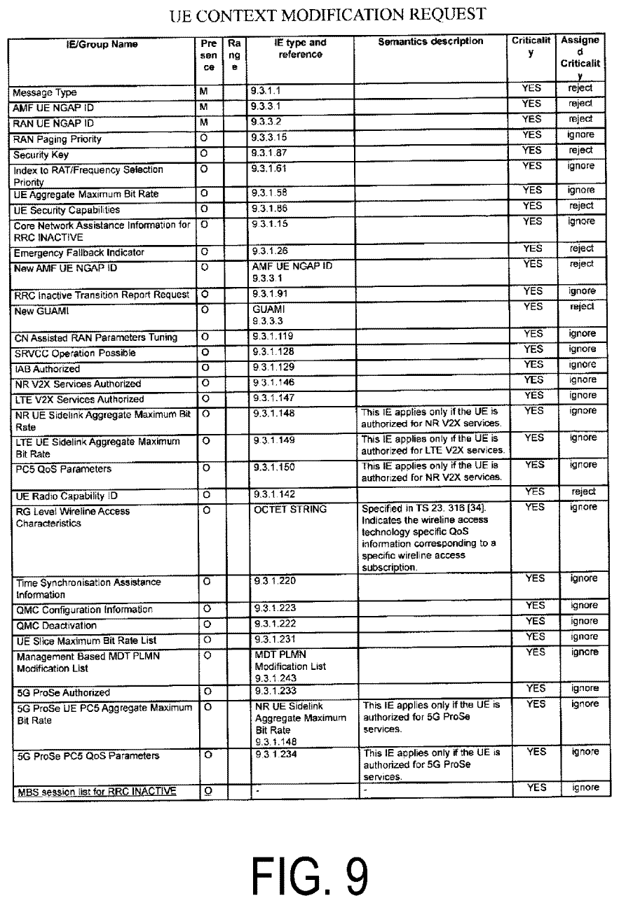

FIG. 9 is a table for explaining a first operation pattern in the first embodiment. In the first operation pattern of the first embodiment, the message including the UE information is a UE context-related message. The AMF 300A transmits the UE context-related message including the UE information to the gNB 200. The gNB 200 receives the UE context-related message.

In the indicated example, the UE context-related message is a UE CONTEXT MODIFICATION REQUEST message that provides a modification on UE context information. The AMF 300A makes, as the modification on the UE context of the UE 100, the UE CONTEXT MODIFICATION REQUEST message to be transmitted to the gNB 200 include an “MBS session list for RRC INACTIVE”, that is a list of IDs of MBS sessions (MBS Session IDs) in which the UE 100 has already joined and is allowed for reception in the RRC inactive state. The UE CONTEXT MODIFICATION REQUEST message includes “AMF UE NGAP ID” and “RAN UE NGAP ID” as the ID of the UE 100. Accordingly, the “AMF UE NGAP ID” and/or the “RAN UE NGAP ID” associated with the “MBS session list for RRC INACTIVE” constitute UE information indicating the UE 100 that has already joined the multicast session and is allowed for multicast reception in the RRC inactive state.

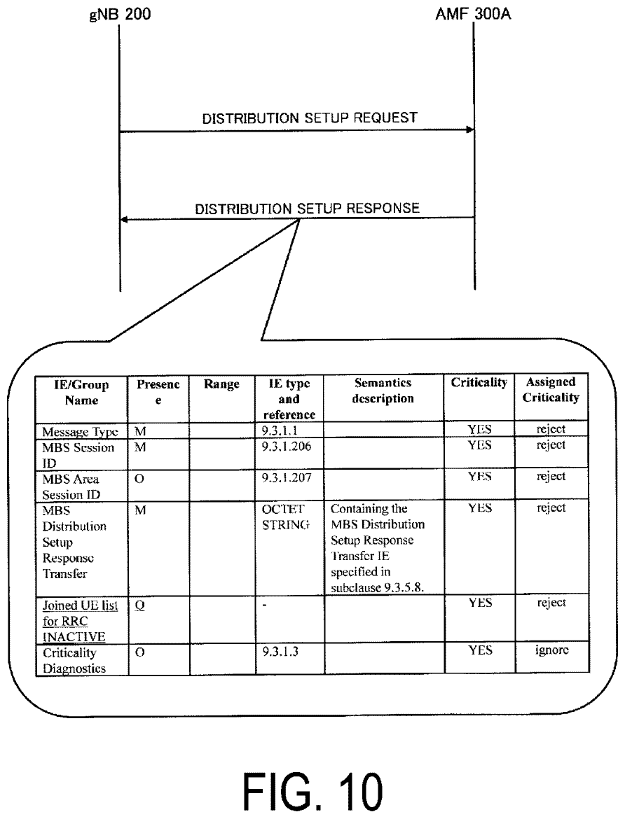

FIGS. 10 to 12 are each a diagram for explaining a second operation pattern in the first embodiment. In the second operation pattern of the first embodiment, the message including the UE information is an MBS-related message. The AMF 300A transmits an MBS-related message including the UE information to the gNB 200. The gNB 200 receives the MBS-related message.

In the example of FIG. 10, the MBS-related message is a “DISTRIBUTION SETUP RESPONSE” message confirming the setup of NG-U transport. Specifically, a Distribution Setup procedure is a procedure for allocating an NG-U resource to a multicast MBS session and includes transmission of a “DISTRIBUTION SETUP REQUEST” message from the gNB 200 to the AMF 300A and transmission of a “DISTRIBUTION SETUP RESPONSE” message from the AMF 300A to the gNB 200. The “DISTRIBUTION SETUP REQUEST” message may include information for the gNB 200 to inquire the presence of a multicast session (and/or UE 100) in which multicast reception in the RRC inactive state is allowed. The “DISTRIBUTION SETUP RESPONSE” message includes an MBS Session ID that is an ID of an MBS session (specifically, a multicast session) and “Joined UE list for RRC INACTIVE”, that is a list of UEs 100 that have already joined the multicast session and are allowed for multicast reception in the RRC inactive state. The “Joined UE list for RRC INACTIVE” may be included in “MBS Distribution Setup Response Transfer” that is an information element transmitted from the SMF 400 to the gNB 200 via the AMF 300A. The MBS-related message may be a “DISTRIBUTION RELEASE RESPONSE” message for confirming the release of the NG-U transport, and the above “DISTRIBUTION SETUP RESPONSE” message may be read as the “DISTRIBUTION RELEASE RESPONSE” message.

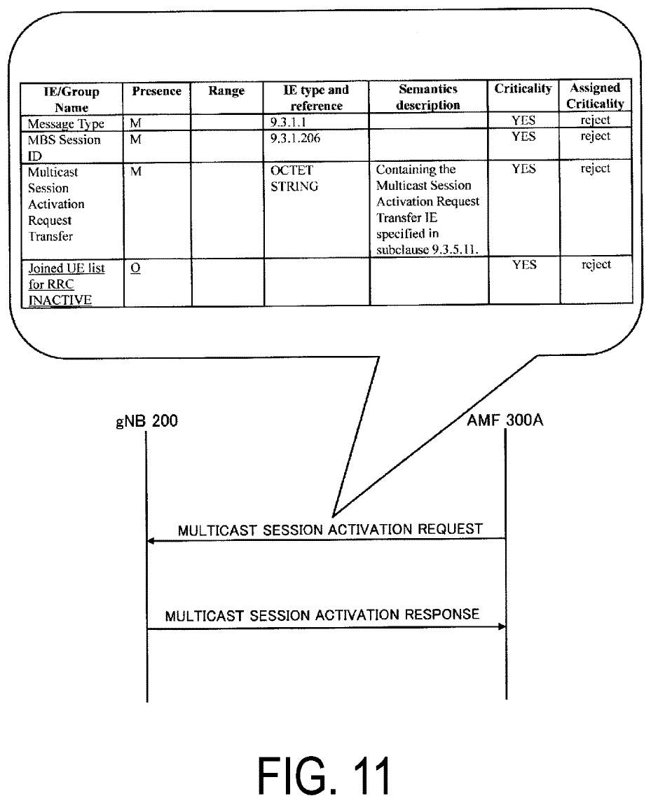

In the example of FIG. 11, the MBS-related message is a “MULTICAST SESSION ACTIVATION REQUEST” message for requesting activation of an MBS session resource for a multicast session. Specifically, a Multicast Session Activation procedure is a procedure for requesting activation of an MBS session resource for a multicast session, and includes transmission of the “MULTICAST SESSION ACTIVATION REQUEST” message from the AMF 300A to the gNB 200 and transmission of a “MULTICAST SESSION ACTIVATION RESPONSE” message from the gNB 200 to the AMF 300A. The “MULTICAST SESSION ACTIVATION REQUEST” message includes an MBS Session ID that is an ID of an MBS session (specifically, a multicast session) and “Joined UE list for RRC INACTIVE”, that is a list of UEs 100 that have already joined the multicast session and are allowed for multicast reception in the RRC inactive state. The “Joined UE list for RRC INACTIVE” may be included in “Multicast Session Activation Request Transfer” that is an information element transmitted from the SMF 400 to the gNB 200 via the AMF 300A. The MBS-related message may be a “MULTICAST SESSION DEACTIVATION REQUEST” message for requesting deactivation of an MBS session resource for a multicast session, and the above “MULTICAST SESSION ACTIVATION REQUEST” message may be read as a “MULTICAST SESSION DEACTIVATION REQUEST” message.

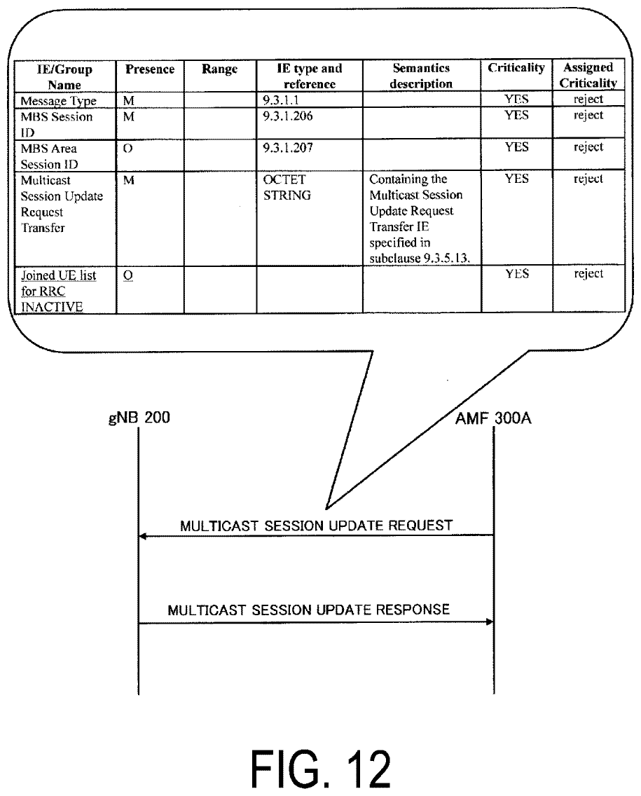

In the example of FIG. 12, the MBS-related message is a “MULTICAST SESSION UPDATE REQUEST” message for updating MBS session resource information. Specifically, a Multicast Session Update procedure is a procedure for updating the MBS session resource information, and includes transmission of the “MULTICAST SESSION UPDATE REQUEST” message from the AMF 300A to the gNB 200 and transmission of a “MULTICAST SESSION UPDATE RESPONSE” message from the gNB 200 to the AMF 300A. The “MULTICAST SESSION UPDATE REQUEST” message includes an MBS Session ID that is an ID of an MBS session (specifically, a multicast session) and the “Joined UE list for RRC INACTIVE”, that is a list of UEs 100 that have already joined the multicast session and are allowed for multicast reception in the RRC inactive state. The “Joined UE list for RRC INACTIVE” may be included in “Multicast Session Update Request Transfer” that is an information element transmitted from the SMF 400 to the gNB 200 via the AMF 300A.

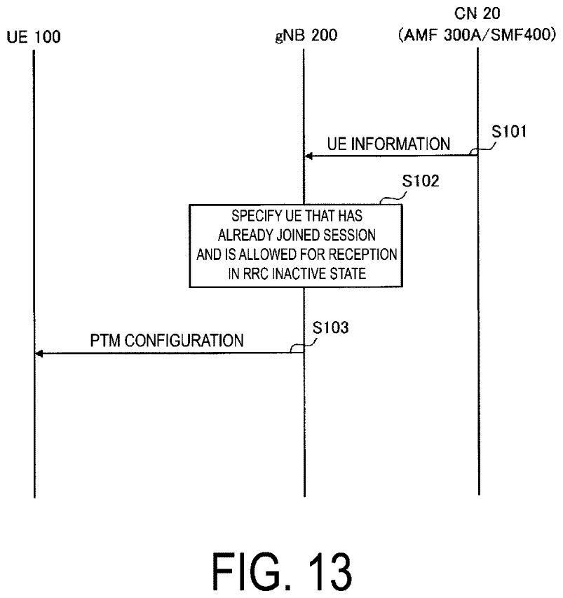

FIG. 13 is a diagram illustrating an example of an operation sequence of the mobile communication system 1 according to the first embodiment. The operation sequence may be performed in combination with the above-described operation sequence (for example, the sequence in FIGS. 7A and 7B).

In step S101, the CN 20, that is, for example, the AMF 300A (or the SMF 400) transmits information on the UE 100 (UE information) that has already joined a multicast session and is allowed reception in the RRC inactive state to the gNB 200. The gNB 200 receives the UE information. Specifically, the AMF 300A transmits a message including the UE information to the gNB 200 via the NG interface. The message is a UE context-related message in the first operation pattern of the first embodiment. The message is an MBS-related message in the second operation pattern of the first embodiment. Note that the UE information may be notified from the SMF 400 to the gNB 200 via the AMF 300A (by storing in the NG-AP container).

In step S102, the gNB 200 specifies, based on the UE information received from the CN 20, the UE 100 that has already joined the multicast session and allows for reception in the RRC inactive state.

In step S103, the gNB 200 transmits a PTM configuration for receiving the multicast session in the RRC inactive state to the UE 100 specified in step S102. For example, the gNB 200 transmits the PTM configuration to the UE 100 on the DCCH. The UE 100 receives the PTM configuration. Note that the UE 100 may be in the RRC connected state in the stage above. Thereafter, the UE 100 may transition to the RRC inactive state and continue reception of the multicast session based on the PTM configuration.

### (1.4) Variation Example of Operation According to First Embodiment

In the above-described first embodiment, an example has been described in which information on the UE 100 (UE information) that has already joined a multicast session and is allowed reception in the RRC inactive state is transmitted from the CN 20 to the gNB 200 while not limited thereto. Instead of or in addition to such UE information, the CN 20 (AMF 300A or SMF 400) may transmit, to the gNB 200, session identification information (TMGI information) that is information on a multicast session that allows for reception in the RRC inactive state. The session identification information may be a list of MBS Session IDs of multicast sessions that allow reception in the RRC inactive state. For example, the AMF 300A transmits, to the gNB 200, a message including the session identification information (UE context-related message or MBS-related message) via the NG interface. Based on the session identification information, the gNB 200 specifies a multicast session that allows for reception in the RRC inactive state, and performs PTM configuration to the UE 100.
(2) Second Embodiment

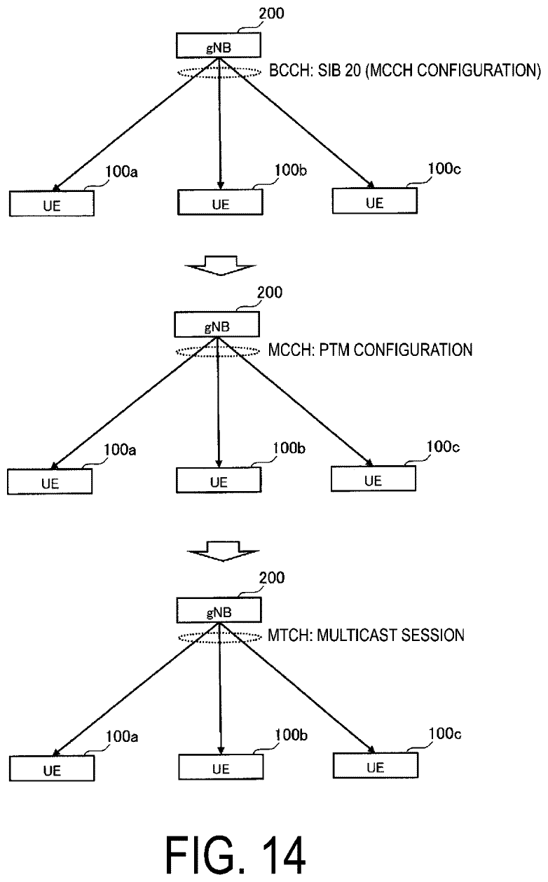

A second embodiment will be described focusing on differences from the first embodiment with reference to FIGS. 14 to 17. Note that the second embodiment may be performed in combination with the first embodiment.

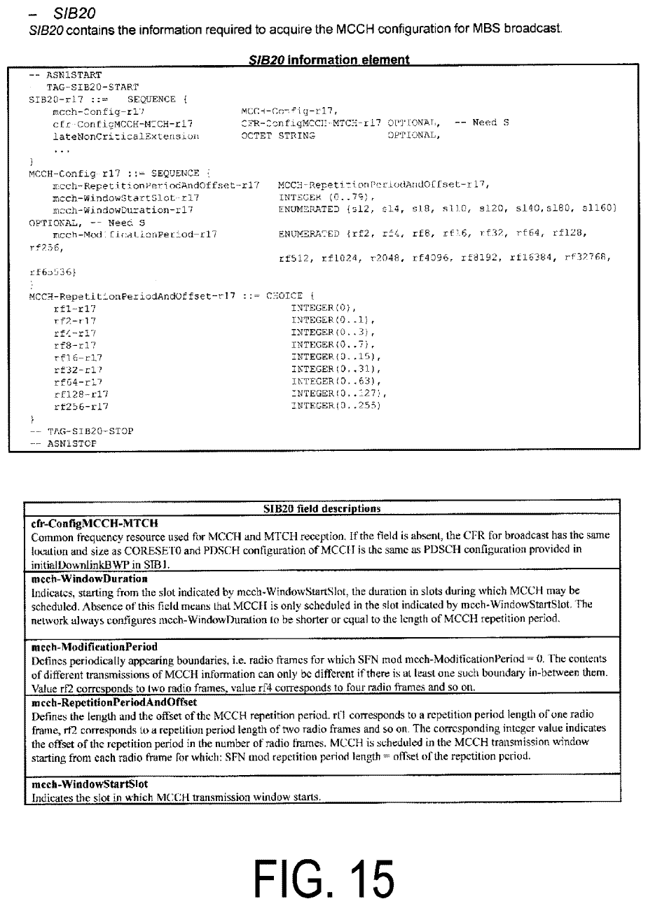

FIG. 14 is a diagram for explaining an operation example (comparative example) when the distribution mode 2 is applied to the MBS multicast. When the distribution mode 2 is applied to the MBS multicast, the following procedure can be considered. Specifically, first, SIB 20 including an MCCH configuration (specifically, scheduling information of the MCCH and the like) is transmitted from the gNB 200 to the UEs 100 (UE 100a to 100c in the illustrated example) on broadcast control channels (BCCHs). FIG. 15 indicates the configuration of the SIB 20 defined in the RRC Technical Specification (TS38.331) of the 3GPP Release 17. The SIB 20 includes an mcch-Config-r17 being the MCCH configuration. Second, the PTM configuration (MTCH configuration) is transmitted from the gNB 200 to the UE 100 on the MCCH. Third, the multicast session (specifically, multicast PTM data) is transmitted from the gNB 200 to the UE 100 on the MTCH.

Here, because the SIB 20 transmission and the MCCH transmission are performed as broadcast, all the UEs 100 in the cell in which the SIB 20 and the MCCH are transmitted may receive the multicast session. However, the specific set of UEs joining a multicast session alone is supposed to receive the MBS multicast. All the UEs 100 being able to acquire the multicast PTM configuration (i.e., the MCCH), therefore, has a concern over security. In the second embodiment, there will be described an operation (communication method) capable of performing appropriate multicast distribution using the MCCH.

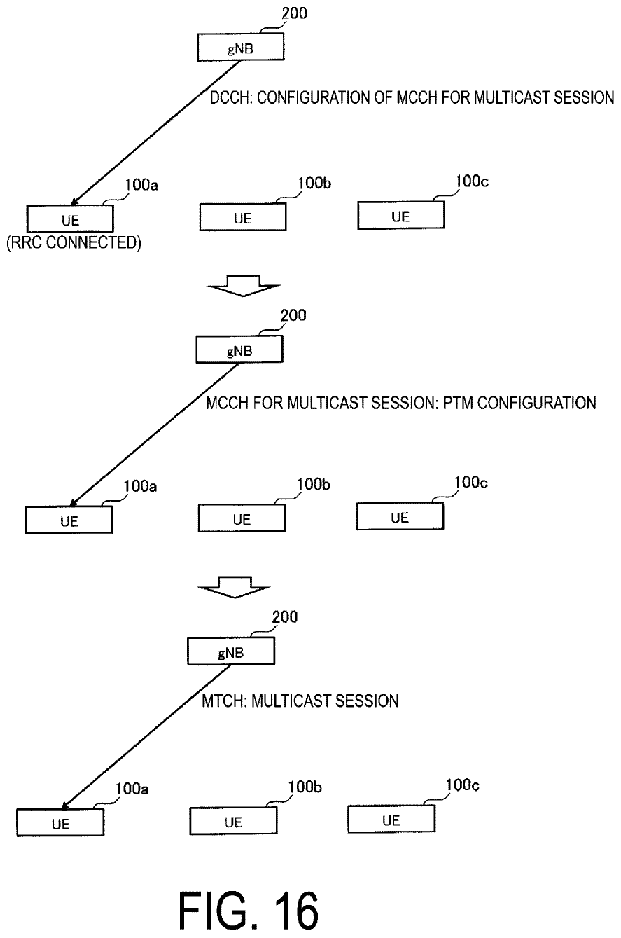

FIG. 16 is a diagram for explaining an operation (communication method) of the mobile communication system 1 according to the second embodiment.

In the communication method according to the second embodiment, first, the gNB 200 transmits scheduling information (MCCH configuration) of the MCCH for carrying the PTM configuration of a multicast session, to the UE 100 in the RRC connected state (UE 100a in the illustrated example), with dedicated signaling (for example, DCCH). The UE 100 receives the MCCH scheduling information (MCCH configuration). Here, the MCCH scheduling information (MCCH configuration) is scheduling information of an MCCH for a multicast session for carrying a PTM configuration of the multicast session. The MCCH for a multicast session is an MCCH different from an MCCH for a broadcast session carrying a PTM configuration of the broadcast session.

Second, the gNB 200 transmits the MCCH for a multicast session. The gNB 200 may transmit the MCCH for a multicast session with scheduling (e.g., time and frequency resource) different from the MCCH for a broadcast session. The UE 100 (UE 100a in the illustrated example) receives the MCCH for a multicast session. At this time, the UE 100 may be in the RRC connected state, the RRC inactive state, or the RRC idle state.

Third, the gNB 200 transmits the multicast session (multicast MBS data) on the MTCH. The UE 100 (UE 100a in the illustrated example) receives the multicast session. At this time, the UE 100 may be in the RRC connected state, the RRC inactive state, or the RRC idle state.

As described above, in the second embodiment, the MCCH configuration for the MCCH for a multicast session is provided to the UE 100 with the dedicated signaling. Thus, the MCCH configuration for a multicast session can be provided only to the specific UE 100 (or a set of the specific UEs 100). Consequently, even when the MCCH is used, only the specific UE 100 (or a set of the specific UEs 100) joining a multicast session can easily receive the multicast session.

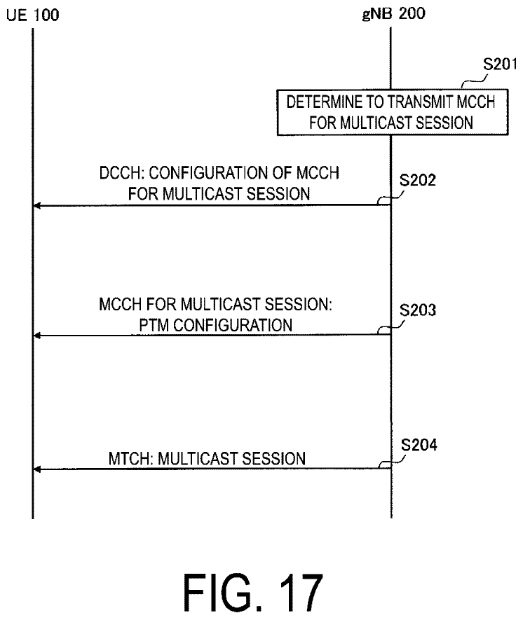

FIG. 17 is a diagram illustrating an example of an operation sequence of the mobile communication system 1 according to the second embodiment.

In step S201, the gNB 200 determines to transmit the MCCH for a multicast session separately from the MCCH for a broadcast session (i.e., the MCCH defined in the 3GPP Release 17). The gNB 200 does not broadcast the scheduling information of the MCCH for a multicast session with the SIB 20. Note that MTCH scheduling information (PTM configuration) of a broadcast session is stored in the MCCH for a broadcast session. The MTCH scheduling information (PTM configuration) of a multicast session is stored in the MCCH for a multicast session.

In step S202, the gNB 200 transmits scheduling information (information corresponding to the content of the SIB 20) of the MCCH for a multicast session to the UE 100 with the dedicated signaling. Here, it is assumed that the UE 100 has already joined the multicast session. The UE 100 receives the scheduling information of the MCCH for the multicast session.

Here, the scheduling information may include a validity duration. For example, the gNB 200 configures a timer value relating to the validity duration to the UE 100. When the timer expires (for example, when the validity duration expires or before the validity duration expires), the UE 100 acquires new scheduling information from the gNB 200 (for example, transitions to the RRC connected state and acquires the new scheduling information).

Note that the gNB 200 may allocate a different MCCH for a multicast session for each MBS session (multicast session). For example, the MCCH for a multicast session may be provided on a one-to-one basis with the multicast session. In the case above, in step S202, the gNB 200 may transmit information associating the multicast session with the MCCH for the multicast session to the UE 100. There may be the UE 100 that has already joined a certain MBS session but has not joined another MBS session. By making the MCCH for a multicast session different for each MBS session (multicast session), it becomes easy for only the UE 100 that has joined a certain MBS session to receive the multicast session.

In step S203, the gNB 200 transmits the MCCH for a multicast session (PTM configuration) with scheduling in accordance with the MCCH scheduling information notified in step S202. The UE 100 receives and acquires the MCCH for a multicast session based on the MCCH scheduling information.

In step S204, the gNB 200 transmits the multicast session on the MTCH with scheduling in accordance with the PTM configuration notified in step S202. The UE 100 receives and acquires the multicast session based on the PTM configuration.

### (3) Other Embodiments

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing each of the processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/only in response to” unless specifically stated otherwise. The phrase “based on” means both “based only on” and “based at least in part on”. The phrase “depending on/in response to” means both “only depending on/only in response to” and “at least partially depending on/at least partially in response to”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplements

Features relating to the above-described embodiments are described below as supplementary notes.

### Supplementary Note 1

A communication method to be used in a mobile communication system providing a Multicast/Broadcast Service (MBS), the communication method including: receiving, at a base station, a message including user equipment information and/or session identification information from a network apparatus provided in a core network, wherein the user equipment information indicates a user equipment that has already joined a multicast session and is allowed for multicast reception in a radio resource control (RRC) inactive state, and the session identification information indicates a multicast session that allows for reception in the RRC inactive state.

### Supplementary Note 2

The communication method of Supplementary Note 1, further including transmitting, at the base station, configuration information for the user equipment to receive a multicast session in the RRC inactive state to the user equipment based on the user equipment information and/or the session identification information.

### Supplementary Note 3

The communication method of Supplementary Note 1 or 2, wherein the message is a UE context-related message or an MBS-related message.

### Supplementary Note 4

A communication method to be used in a mobile communication system providing a Multicast/Broadcast Service (MBS), the communication method including:
receiving, at a user equipment in an RRC connected state, scheduling information of a multicast control channel (MCCH) carrying a point-to-multipoint (PTM) configuration of a multicast session from a base station with dedicated signaling;
receiving the PTM configuration through the MCCH from the base station based on the scheduling information of the MCCH; and receiving the multicast session from the base station based on the PTM configuration.

### Supplementary Note 5

The communication method of Supplementary Note 4, wherein the MCCH is an MCCH for a multicast session carrying the PTM configuration of the multicast session, and the MCCH for a multicast session is an MCCH different from an MCCH for a broadcast session carrying a PTM configuration of a broadcast session.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method to be used in a mobile communication system providing a Multicast/Broadcast Service (MBS), the communication method comprising:
receiving, at a user equipment in a radio resource control (RRC) connected state, an RRC Release message including configuration information of a multicast control channel (MCCH) carrying a point-to-multipoint (PTM) configuration of a multicast session, from a network node.

2. The communication method according to claim 1, further comprising
receiving, at the user equipment in the RRC connected state, the PTM configuration from the network node.

3. The communication method according to claim 2, further comprising
receiving, at the user equipment, the multicast session from the network node based on the PTM configuration.

4. The communication method according to claim 1, wherein
the MCCH is an MCCH for a multicast session carrying the PTM configuration of the multicast session, and
the MCCH for a multicast session is an MCCH different from an MCCH for a broadcast session carrying a PTM configuration of a broadcast session.

5. The communication method according to claim 1, wherein
the configuration information includes information indicating common frequency resources used for reception of the MCCH and a Multicast Traffic Channel (MTCH).

6. The communication method according to claim 1, wherein
the configuration information includes information indicating a period in slots in which the MCCH can be scheduled.

7. The communication method according to claim 1, wherein
the configuration information includes information indicating a period in which information transmitted on the MCCH can be changed.

8. The communication method according to claim 1, wherein
the configuration information includes information indicating a length and an offset of a repetition period of the MCCH.

9. The communication method according to claim 1, wherein
the configuration information includes information indicating a slot in which a transmission window of the MCCH starts.

10. A user equipment for use in a mobile communication system providing a Multicast/Broadcast Service (MBS), the user equipment comprising:
a receiver configured to receive, from a network node, a radio resource control (RRC) Release message including configuration information of a Multicast Control Channel (MCCH) carrying a point-to-multipoint (PTM) configuration of a multicast session, in a case where the user equipment is in an RRC connected state.

11. A network node for use in a mobile communication system providing a Multicast/Broadcast Service (MBS), the network node comprising:
a transmitter configured to transmit, to a user equipment in a radio resource control (RRC) connected state, an RRC Release message including configuration information of a Multicast Control Channel (MCCH) carrying a point-to-multipoint (PTM) configuration of a multicast session.

12. A processor for causing a user equipment to execute the communication method according to claim 1.

13. A mobile communication system comprising:
the user equipment according to claim 10; and
the network node.
